(19) United States
(12) Patent Application Publication
(10) Pub. No.: US 2004/0261381 A1
(43) Pub. Date: Dec. 30, 2004

(54) Filter element

(75) Inventor: Wolfgang Heikamp, Waldsee (DE)

Correspondence Address: CROWELL & MORING LLP, INTELLECTUAL PROPERTY GROUP, P.O. BOX 14300, WASHINGTON, DC, 20044-4300, US

(73) Assignee: MANN & HUMMEL GMBH, Ludwigsburg (DE)

(21) Appl. No.: 10/608,430

(22) Filed: Jun. 30, 2003

(51) Int. Cl. B01D 46/00

(52) U.S. Cl. 55/486

(57) ABSTRACT

A filter element for filtering a gas stream including filter mats (4, 6) positioned in the gas stream, to which particles in the gas stream (2, 9) adhere and can be removed from the gas stream. The filter mats (4, 6) advantageously comprise multiple layers of the filter material having a membrane (5) positioned between them. The filter mats (4, 6) may additionally be provided on inflow side with a pre-separator nonwoven web (3) and/or on the outflow side with a post-separator nonwoven web (7) and each comprise, for example, 5 to 10 individual layers of glass fiber paper.

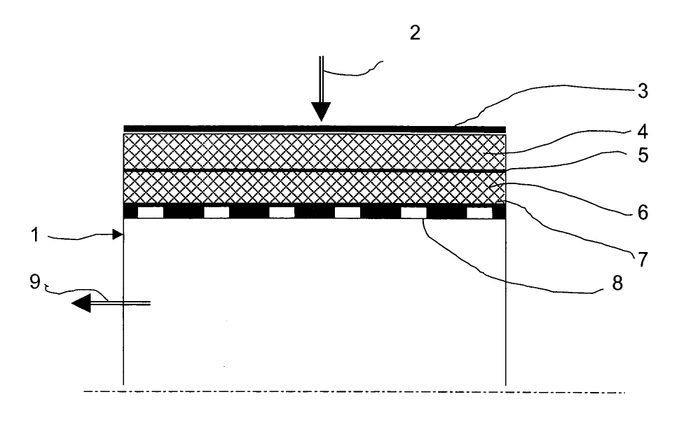

### BACKGROUND OF THE INVENTION

The present invention relates to a filter element and, in particular, to a filter element for de-oiling a gas stream.

A filter element having a filter web, which forms a hollow cylinder, through which the fluid to be filtered flows radially from the outside in, and in which the filtered fluid is conducted centrally out of the filter element, is known, for example, from German Utility Model 94 03 868.6 U1. In the known filter element, the material of the filter web is paper, felt, or a nonwoven web of synthetic resin fibers. These filter elements are inserted as replaceable filter elements into a corresponding filter housing.

In an arrangement of this type, which is used, for example, for de-oiling air in compressors or vacuum pumps, the properties of the filter layers play a large role due to the relatively high mechanical stresses.

### SUMMARY OF THE INVENTION

It is an object of the present invention to provide an improved filter element, particularly an improved de-oiling filter element.

Another object of the invention is to provide a filter element which can handle a heavy load while occupying a small overall space.

These and other objects are achieved in accordance with the present invention by providing a filter element for filtering a gas stream, wherein the filter element includes at least one filter mat positioned in the gas stream to which particles in the gas stream can adhere and be removed from the gas stream, and wherein the at least one filter mat includes a plurality of layers of a filter material having a membrane disposed between them.

The filter element according to the present invention is advantageous in that the filter mats, which are positioned in the gas stream and to which particles in the gas stream adhere and can be removed from the gas stream, include a plurality of layers of a filter material having a membrane positioned between them.

Therefore, even if the filter mats comprise 5 to 10 individual layers of a suitable filter material on each side of the membrane and are optionally provided on the inflow side with a nonwoven pre-separation web and/or on the outflow side with a nonwoven post-separation web, the overall size of the filter element may advantageously be kept small. Suitable filter materials for the layers of the filter mats in this case may include, in particular, paper made from glass fibers, synthetic resin fiber nonwoven webs, and/or felts.

In accordance with one aspect of the invention, the membrane may be of any suitable type. Given the design specification for a particular application, a person with ordinary skill in the art, based on the established practice in the art, can determine what types of membranes are suitable for use in the application.

In accordance with another aspect of the invention, the porosity of the membrane preferably is greater than 60%, although the porosity of the membrane can be of any suitable value. In some applications, the porosity of the membrane may be greater than 40% or greater than 80%. Additionally, although the pore size of the membrane can be of any suitable value, the range of the membrane's pore size is preferably from 0.2 μm to 10 μm, more preferably from 2 μm to 8 μm, and most preferably from 4 μm to 6 μm. The thickness of the membrane may also be suitably selected. A preferred range of membrane thickness is from 25 μm to 250 μm, although other ranges, such as the range of 10 μm to 500 μm or the range of 50 μm to 200 μm, may also be used.

Membranes having the preferred physical properties have exceptional advantages and can achieve surprising results. For example, when its porosity is above 60%, a membrane normally is not very effective at achieving a high degree of separation. When used with the present invention, however, a membrane with a porosity above 60% can unexpectedly achieve a high degree of separation. Additionally, when its thickness is within the range of 25 μm to 250 μm, a membrane also may not be very effective at achieving a high degree of separation. However, the same membrane can unexpectedly achieve a high degree of separation when used with the present invention.

In accordance with still another aspect of the invention, the membrane may have a symmetrical or asymmetrical structure. For any particular application, a person with ordinary skill in the art can determine what the suitable membrane texture is, based on the established practice in the art.

The membrane may be made from any suitable material. For example, the membrane may be made from a highly porous polymer. In some applications, the suitable materials may include one or more of polysulfone, polyethersulfone, Teflon, polyether, polypropylene, polyester and mixed esters.

In accordance with a further aspect of the invention, the membrane may be made from nanofibers. Preferably, the average fiber diameter of the nanofibers is within the range of 50 nm to 1000 nm, or more preferably from 50 nm to 100 nm. The specific weight of the nanofiber membrane is preferably from about 20 g/m² to about 200 g/m² or more preferably at about 20 g/m².

In one advantageous embodiment of the present invention, the filter mats have the configuration of a hollow cylinder mounted on a perforated, preferably metallic central tube, so that the gas stream to be filtered flows against it radially from the outside and may be guided axially out of the filter element.

The filter element according to the present invention is advantageously usable for de-oiling an air stream in compressors or vacuum pumps. In this way, the overall space occupied by a filter element of the present invention may be reduced to approximately two-thirds of the overall space occupied by a conventional filter element, with a simultaneous reduction of the pressure loss by up to 20%. In addition, the service life of the filter element is not expected to be impaired.

### BRIEF DESCRIPTION OF THE DRAWING

The invention will be described in further detail hereinafter with reference to an illustrative preferred embodiment shown in the accompanying drawing FIGURE, which is a sectional view through the filter layers of a hollow cylindrical filter element.

### DETAILED DESCRIPTION OF PREFERRED EMBODIMENTS

The drawing FIGURE depicts a filter element 1, which may be used, for example, for de-oiling air in a compressor or vacuum pump. The air passes, as shown by arrow 2, through a pre-separator nonwoven web 3 and then flows through a filter mat 4 made of, for example, from 1 to 20 layers of glass fiber paper, through a membrane 5, and then through a further filter mat 6, also made of from 1 to 20 layers of glass fiber paper. In a preferred embodiment, each mat may be made, for example, of five layers of glass fiber paper.

Furthermore, a post-separator nonwoven web 7 is also present. This entire arrangement is supported on a typically metallic central tube 8. The de-oiled air may then flow axially out of the filter element 1 as indicated by arrow 9.

The foregoing description and example have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A filter element for filtering a gas stream, comprising at least one filter mat positioned in the gas stream to which particles in the gas stream can adhere and be removed from the gas stream, wherein the at least one filter mat comprises a plurality of layers of a filter material and a membrane disposed between the layers.

2. A filter element according to claim 1, further comprising a pre-separator nonwoven web on an inflow side of the at least one filter mat.

3. A filter element according to claim 1, further comprising a post-separator nonwoven web on an outflow side of the at least one filter mat.

4. A filter element according to claim 1, wherein the at least one filter mat comprises from 1 to 20 individual layers made of glass fiber paper on each side of the membrane.

5. A filter element according to claim 1, wherein the at least one filter mat comprises from 1 to 20 individual layers of synthetic resin fiber nonwoven web material on each side of the membrane.

6. A filter element according to claim 1, wherein the at least one filter mat comprises from 1 to 20 individual layers of felt on each side of the membrane.

7. A filter element according to claim 1, wherein the at least one filter mat has the configuration of a hollow cylinder and is mounted on a perforated central tube so that the gas stream flows radially through the filter element from the outside in and exits the filter element axially from the center of the cylindrical filter element.

8. A filter element according to claim 1, wherein the filter element is used for de-oiling an airstream in a compressor or a vacuum pump.

9. A filter element according to claim 1, wherein the membrane is a highly porous polymer membrane having a porosity greater than 60% and a pore size between 0.1 μm and 10 μm.

10. A filter element according to claim 1, wherein the membrane has a symmetrical or asymmetrical structure.

11. A filter element according to claim 1, wherein the membrane has a thickness in the range of 25 μm to 250 μm.

12. A filter element according to claim 1, wherein the membrane is made from one or more of polysulfone, polyethersulfone, Teflon, polyether, polypropylene, polyester, and mixed esters.

13. A filter element for filtering a gas stream, comprising at least one filter mat positioned in the gas stream to which particles in the gas stream can adhere and be removed from the gas stream, wherein the at least one filter mat comprises a plurality of layers of a filter material and a membrane disposed between the layers, wherein the membrane includes at least one layer of nanofiber material that is made from polyamide and has a fiber diameter of 50 nm to 1000 nm and a specific weight of 20 g/m² to 200 g/m².
